(19) United States
(12) Patent Application Publication
(10) Pub. No.: US 2021/0288908 A1
(43) Pub. Date: Sep. 16, 2021

(54) ELIMINATION OF ADDRESS RESOLUTION PROTOCOL

(71) Applicant: Schweitzer Engineering Laboratories, Inc., Pullman, WA (US)

(72) Inventors: Rhett Smith, Odessa, FL (US); Jason A. Dearien, Moscow, ID (US); Dennis Gammel, Pullman, WA (US)

(73) Assignee: Schweitzer Engineering Laboratories, Inc., Pullman, WA (US)

(21) Appl. No.: 16/817,177

(22) Filed: Mar. 12, 2020

(51) Int. Cl. H04L 12/741

(52) U.S. Cl. CPC H04L 45/74

(57) ABSTRACT

The present disclosure pertains to systems and methods for eliminating Address Resolution Protocol (ARP) traffic in data networks. In one embodiment, a controller in a software-defined network (SDN) may generate a plurality of communication flows. The controller may program a plurality of network devices in a data plane based on the plurality of communication flows. A packet to be transmitted in the data plane may be received from a transmitting host by one of the plurality of network devices. A destination host specified in the packet may be determined without reliance on an original media access control (MAC) address in the packet, and the packet may be routed to the destination host.

### TECHNICAL FIELD

The present disclosure relates to systems and methods for eliminating address resolution protocol (“ARP”) traffic in a communication network. More particularly, but not exclusively, the techniques disclosed in the present application may be used to eliminate ARP in a software-defined network (“SDN”) to increase security and decrease network traffic and utilization.

### BRIEF DESCRIPTION OF THE DRAWINGS

Non-limiting and non-exhaustive embodiments of the disclosure are described, including various embodiments of the disclosure, with reference to the figures, in which:

FIG. 1 illustrates a conceptual representation of communication within a network consistent with embodiments of the present disclosure.

FIG. 2 illustrates a conceptual representation of an SDN including a plurality of applications, a control plane, a data plane, and a plurality of data-consuming and data-producing hosts that may be deployed in a system consistent with embodiments of the present disclosure.

FIG. 3 illustrates a block diagram of a system including an SDN controller, a switch, and a plurality of hosts consistent with embodiments of the present disclosure.

FIG. 4 illustrates a flowchart of a method for transmitting a message in an SDN consistent with the embodiments in the present disclosure.

### DETAILED DESCRIPTION

Commonly, ARP is used for hosts in a network to discover link-layer addresses, such as a media access control (“MAC”) address, associated with an internet layer address, such as an IPv4 address. The use of ARP within a communication network may enable various forms of attacks, including man-in-the-middle attacks, ARP poisoning, and denial of service attacks. Using such techniques, an intruder may intercept or disrupt communications intended for other devices in the network. Minimizing or eliminating the ability to conduct such attacks may improve the security of a communication network.

Systems and methods disclosed herein may enable communication systems to operate without ARP, and thus eliminate the security threats associated with ARP. Various embodiments may utilize SDNs or modified network stacks to eliminate the need for ARP in a communication network.

In certain embodiments, a network stack may be modified to eliminate the need for MAC addresses and/or ARP. In the Open Systems Interconnection (OSI) model, the MAC address is utilized at layer 2, or the data link layer. In a network adapter consistent with the present embodiment, layer 2 may be modified such that MAC addresses are discarded or utilized for another purpose. Such modifications may be made directly in a network interface, and thus may be transparent to higher levels of the network stack, such as the application layer. In such embodiments, MAC addresses may be fixed values, random values, or values used to communicate other information (e.g., a message type).

SDN systems may be used in a variety of applications to configure and manage a network and to achieve a variety of benefits, such as deny-by-default security, deterministic transit times, latency control, symmetric transport capabilities, redundancy, fail-over planning, etc. These and other features have made SDNs an attractive technology for critical infrastructure, such as electrical power systems, telephone systems, and the like. The present disclosure includes several specific examples related to electric power systems; however, one of skill in the art will recognize that the present disclosure may be adapted for use in any number of specific applications or industries.

SDN networking technologies allow programmatic changes to a network and allow an entire communication network to be managed as a single asset, which may simplify the management of the network, and enable continuous monitoring of the network. In an SDN, the control plane, which forwards the traffic, is separated from the data plane, which performs the forwarding of the traffic in the network. In contrast, in conventional networking devices, the control plane and the data plane are typically implemented in a single device (i.e., a network router or switch). A conventional networking device may generate an address table or database to process communications.

The control plane may be used to create communication flows through the network. A communication flow establishes devices that are authorized to communicate with one another. A communication flow, as the term is used herein, refers to a set of parameters used to match and take action based on network packet contents. Communication flows enable communication between devices based on a variety of criteria and offer significant control and precision to operators of the network. In contrast, in large traditional networks, trying to match a network-discovered path with a desired data path may be a challenging task involving changing configurations in many devices. To compound this problem, the management interfaces and feature sets used on many devices are not standardized. Still, further, network administrators often need to reconfigure the network to avoid loops, gain route convergence speed, and prioritize a certain class of applications.

Significant complexity in managing a traditional network, for example, in the context of an electric power transmission and distribution system, arises from the fact that each network device (e.g., a switch or router) has control logic and data-forwarding logic integrated together. For example, in traditional network appliances, dynamic control plane protocols such as Routing Information Protocol, Open Shortest Path First, Spanning Tree Protocol, Address Resolution Protocol, and the other dynamic control plane protocols may be used to determine how a packet should be forwarded. The paths determined by the routing protocol are encoded in address tables, which are then used to forward packets. Similarly, in a Layer 2 device such as a network bridge (or network switch), configuration parameters and/or a Spanning Tree Algorithm constitute the control logic that determines the path of the packets. Thus, the control plane in a traditional network is distributed in the switching fabric of the network.

In an SDN, a controller embodies the control plane and determines how packets (or frames) should flow (or be forwarded) in the data plane of the network. The controller communicates this information to the network devices, which constitute the data plane, by setting their forwarding tables. This enables centralized configuration and management of a network. As such, the data plane in an SDN may consist of relatively simple packet-forwarding devices with a communications interface to the controller to receive forwarding decisions. In addition to simplifying management of a network, an SDN architecture may also enable monitoring and troubleshooting features that may be beneficial in critical infrastructure, including but not limited to: mirroring a data-selected flow rather than mirroring a port; alarming on bandwidth near saturation; providing metrics (e.g., counters and meters for quality of service, packet counts, errors, drops, or overruns, etc.) for a specified flow, permitting monitoring of specified applications rather than monitoring based on virtual local area networks or MAC addresses, and/or monitoring destinations of ARP requests.

An SDN may operate on and control packet sequences by a variety of techniques, including meter entries, flow entries, and group entries. Flow entries define how a switch in the data plane is to handle packets. The flow entry operates on a packet when there is a match between some criteria of the packet and the flow entry's match fields. Group entries may be utilized to enhance the forwarding behavior of the communication flows and to apply Quality of Service policies to the packet. In various embodiments consistent with the present disclosure, the OpenFlow protocol may be utilized to control communication devices in a data plane of an SDN.

Using the systems and methods disclosed herein, an SDN network may alter the manner in which MAC addresses are used or may eliminate the significance of MAC addresses altogether. MAC addresses may be eliminated in some embodiments because authorized communications are routed according to software flows controlled by the SDN controller. Authorized communications between devices may be allowed by specified flows that do not rely on the ARP protocol to discover MAC addresses.

Embodiments consistent with the present disclosure may be utilized in a variety of communication devices. A communication device, as the term is used herein, is any device that is capable of accepting and forwarding data traffic in a data communication network. Communication devices may include switches, routers, bridges, firewalls, gateways, etc. In addition to the functionality of accepting and forwarding data traffic, communication devices may also perform a wide variety of other functions and may range from simple to complex devices.

The embodiments of this disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once unless otherwise specified.

In some cases, well-known features, structures, or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Several aspects of the embodiments described may be implemented as software modules or components. As used herein, a software module or component may include any type of computer instruction or computer-executable code located within a memory device and/or transmitted as electronic signals over a system bus or wired or wireless network. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product, including a non-transitory computer and/or machine-readable medium having stored thereon instructions that may be used to program a computer (or another electronic device) to perform processes described herein. For example, a non-transitory computer-readable medium may store instructions that, when executed by a processor of a computer system, cause the processor to perform certain methods disclosed herein. The non-transitory computer-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of machine-readable media suitable for storing electronic and/or processor-executable instructions.

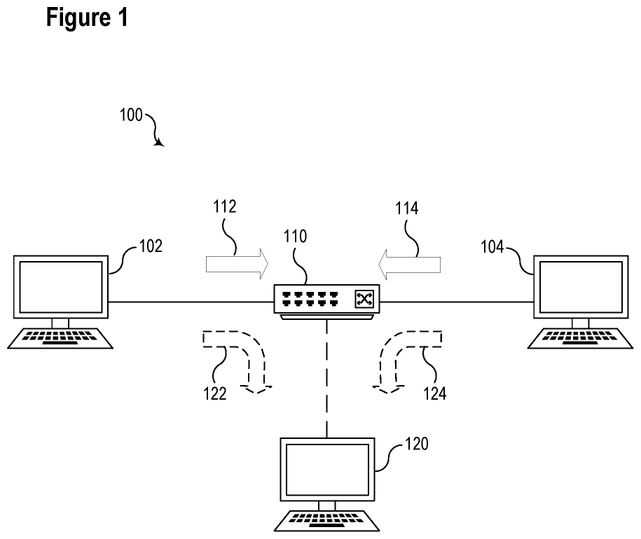

FIG. 1 illustrates a conceptual representation of communication within a network 100 consistent with embodiments of the present disclosure. Computer systems or hosts 102 and 104 are in communication with a switch 110. Commonly, ARP is used for hosts in a network to discover link-layer addresses, such as a MAC address, associated with an internet layer address, such as an IPv4 address. When a host (e.g., host 102) has a packet to send to an IP address, the host may examine a routing table. If the IP address is not associated with a MAC address, the host 102 may send a broadcast ARP request message, as indicated by arrow 112. The broadcast ARP request message is sent to all computers on the local network so that the host with the corresponding destination IP address will receive and respond to the message. The computer associated with the IP address in question (e.g., host 104) may respond, as indicated by arrow 114, with an ARP response message containing its MAC and IP addresses.

ARP is a stateless protocol that does not authenticate the peer from which a response packet originated, and accordingly, ARP replies can come from systems other than the one with the desired Layer 2 address. A Network host using ARP will automatically cache an ARP reply sent on the network, regardless of whether the receiving host transmitted the request. Accordingly, ARP entries that have not yet expired are overwritten when a new ARP reply packet is received. These issues leave hosts using ARP vulnerable to ARP spoofing.

An attacker 120 may take advantage of the lack of authentication to send spoofed ARP messages. Such messages may seek to associate the attacker's MAC address with the IP address of another host, causing traffic for the other host to be routed to the attacker. ARP spoofing may allow attacker 120 to engage in a man-in-the-middle attack in which traffic flowing between hosts 102 and 104 is routed to attacker 120, as indicated by arrows 122 and 124. The attacker 120 may inspect the traffic. Further, the attacker 120 may seek to avoid detection by forwarding the data to the intended destination. The attacker 120 has the option of forwarding the original data or altering the data. Alteration of data may be used to corrupt the communication between hosts 102 and 104. Alternatively, the data may be discarded by attacker 120, thus cutting off communication between hosts 102 and 104.

In various embodiments consistent with the present disclosure, various techniques may be utilized to eliminate the need for ARP and its associated vulnerabilities. For example, hosts 102 and 104 may have fixed routing tables. The fixed routing tables may take precedence over ARP messages, thus preventing attacker 120 from intercepting or disrupting communications between hosts 102 and 104.

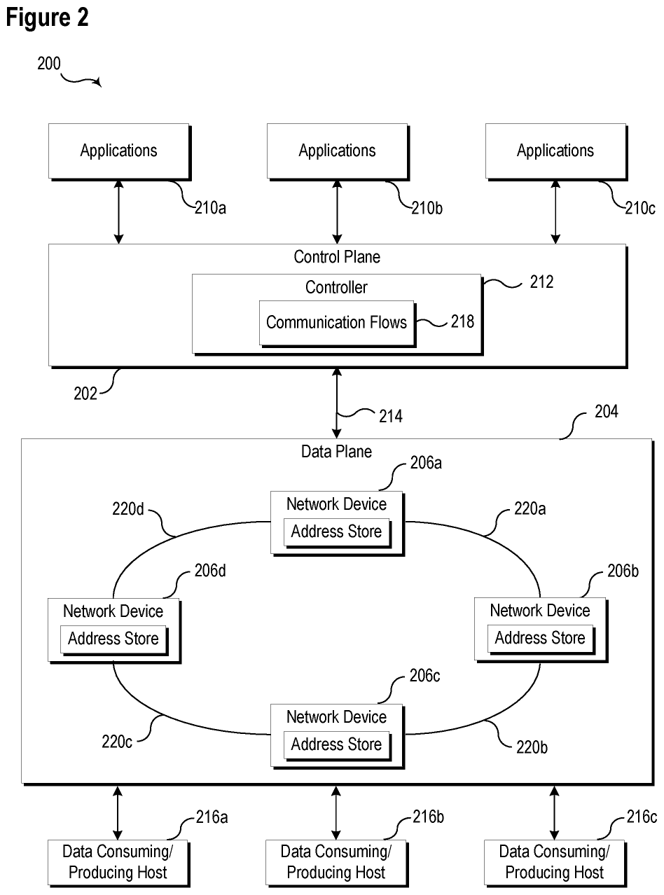

FIG. 2 illustrates a conceptual representation of an SDN 200 including a plurality of applications 210a, 210b, and 210c, a control plane 202, a data plane 204, and a plurality of data-consuming and data-producing hosts 216a-216c that may be deployed in a system consistent with embodiments of the present disclosure. The control plane 202 directs the flow of data through the data plane 204. More specifically, a controller 212 in the control plane 202 may communicate with a plurality of network devices 206a, 206b, 206c, and 206d via an interface 214 to establish communication flows 218. Network devices 206a, 206b, 206c, and 206d may be connected by communication links 220a, 220b, 220c, and 220d. The communication links 220a, 220b, 220c, and 220d may be embodied as a variety of data communication channels, including Ethernet, fiber optic, etc. The controller 212 may specify rules for routing traffic through the data plane 204 based on a variety of criteria. SDN 200 allows for the implementation of communication using IEEE 802 protocols but enables an operator to disable or block certain types of communications, such as ARP.

Communication flows 218 establish which hosts 216a, 216b, and 216c may communicate with each other. For example, a communication flow 218 may enable communication between hosts 216a and 216b. Accordingly, traffic between hosts 216a and 216b may be permitted so long as such communications satisfy the requirements of the communication flow 218.

According to a deny-by-default security policy, a lack of a communication flow 218 enabling communication between two devices prevents communications between these devices. For example, a lack of a communication flow 218 permitting communication between hosts 216a and 216c may result in all communications, including ARP messages, from host 216a for the IP address of host 216c being blocked by a network device. As such, when a message is routed to a particular device through an SDN, the receiving device may be configured to trust the authenticity and content of the message.

In critical infrastructure applications and many other professionally managed networks, IP addresses are static and are known to controller 212. Controller 212 may create flows to route traffic without regard to MAC addresses. Accordingly, in some embodiments, the MAC address may be fixed (e.g., 11:11:11:11:11:11) or randomly generated by a transmitting device. Messages routed to a host device may be filtered based solely on an IP address and without regard to a MAC address. Still further, the MAC address may be repurposed to communicate other information. In one specific embodiment, MAC addresses may be repurposed and used to designate a type or category of messages or a message priority.

The data consuming/producing hosts 216a-216c may represent a variety of devices that produce or consume data within a system. For example, data consuming/producing hosts 216a-216c may, for example, be embodied as a pair of transmission line relays configured to monitor an electrical transmission line. The transmission line relays may monitor various aspects of the electric power flowing through the transmission line (e.g., voltage measurements, current measurements, phase measurements, synchrophasors, etc.) and may communicate the measurements to implement a protection strategy for the transmission line. Traffic between the transmission line relays may be forwarded through the data plane 204 using a plurality of communication flows implemented by controller 212. Of course, data consuming/producing devices 216a-216c may be embodied by a wide range of devices consistent with embodiments of the present disclosure.

In embodiments utilized in connection with electric power systems, data consuming/producing hosts 216a-216c may be embodied as a wide range of devices ranging from relatively simple embedded devices to intelligent electronic devices (IEDs). As used herein, an IED may refer to any microprocessor-based device that monitors, controls, automates, and/or protects monitored equipment within a system. Such devices may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communications processors, computing platforms, programmable logic controllers (PLCs), programmable automation controllers, input and output modules, and the like. The term IED may be used to describe an individual IED or a system comprising multiple IEDs. Embedded devices may comprise relatively simple devices to perform a specific function. Such devices may include, for example, contact sensors, status sensors, light sensors, tension sensors, and the like.

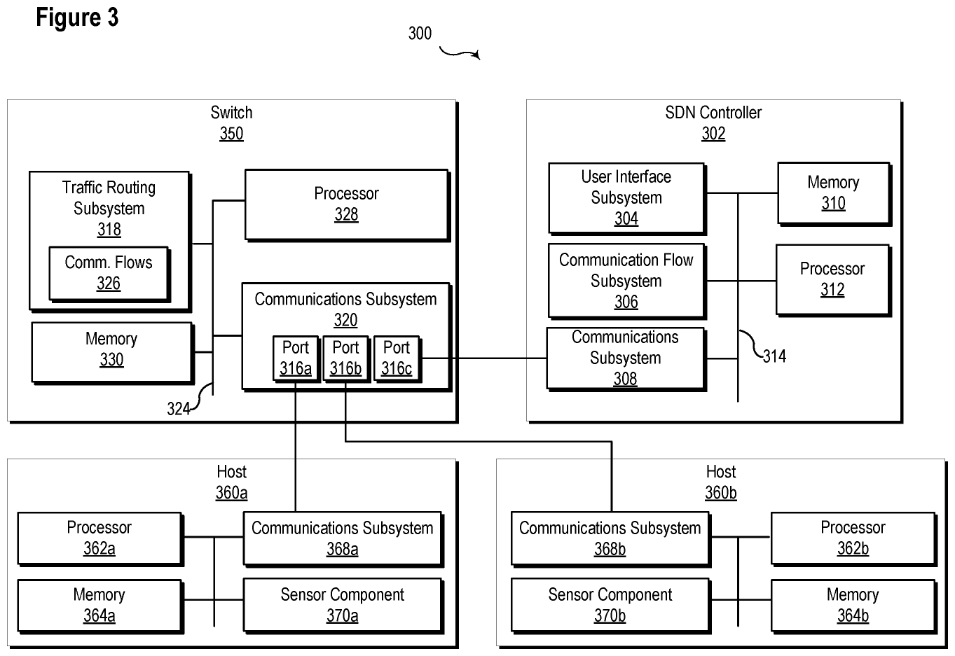

FIG. 3 illustrates a block diagram of a system 300 including an SDN controller 302, a switch 350, and hosts 360a and 360b consistent with embodiments of the present disclosure. In some embodiments, system 300 may be implemented using hardware, software, firmware, and/or any combination thereof. Moreover, certain components or functions described herein may be associated with other devices or performed by other devices. The specifically illustrated example is merely representative of one embodiment consistent with the present disclosure.

SDN controller 302 includes a processor 312 that processes information and coordinates the operation of the other components of SDN Controller 302. A data bus 314 may facilitate communication among various components of SDN controller 302. Instructions to be executed by processor 312 may be stored in memory 310. Processor 312 may operate using any number of processing rates and architectures. Processor 312 may be used to perform any of the various algorithms and calculations described herein. Processor 312 may be embodied as a general-purpose integrated circuit, an application-specific integrated circuit, a field-programmable gate array, and/or any other suitable programmable logic device. Such instructions may include information for processing and routing data packets received via communications subsystem 308. Memory 310 may comprise a variety of types of computer-readable media suitable for storing instructions related to the operation of SDN controller 302. For example, memory 310 may comprise a hard disk drive, flash memory, or another form of non-volatile memory. Memory 310 may also comprise random-access memory (RAM) for storage of information during operation of SDN controller 302.

A communication flow subsystem 306 may be used to generate and implement a variety of communication flows. Communication flows generated by communication flow subsystem 306 may specify which devices are authorized to communicate in system 300. Further, communication flows may specify a route through a variety of intermediate devices (e.g., routers, switches, multiplexers, etc.), although only one switch is illustrated in FIG. 3 in the interest of simplicity. Where system 300 is configured to implement a deny-by-default scheme, communications are blocked that are not specifically authorized by communication flows.

Communication flows may be implemented without reliance on MAC addresses, thus eliminating the need for ARP messages within system 300. In some embodiments, the MAC address field in a data packet may be repurposed to communicate other information (e.g., message type, message priority, etc.). Alternatively, a transmitting device may insert a fixed value or a random value into a packet to be transmitted. The actual MAC address associated with a recipient may be added or substituted into the packet by another device in the data plane of the SDN network.

A communications subsystem 308 may enable communication between SDN controller 302 and other devices in system 300. In various embodiments, the communications subsystem 308 may be configured to communicate via a variety of communication links, including Ethernet, fiber optic, and other forms of data communication channels. Communications subsystem 308 may allow communication with switch 350 and may allow SDN controller 302 to program switch 350 to implement communication flows. Although not illustrated in FIG. 3, SDN controller 302 may be in communication with a plurality of other devices, such as additional switches, routers, firewalls, devices, and other systems.

Switch 350 includes a processor 328 that processes information and coordinates the operation of the other components of switch 350. A data bus 324 may facilitate communication among various components of switch 350. Instructions to be executed by processor 328 may be stored in memory 330. Processor 328 may operate using any number of processing rates and architectures. Processor 328 may be used to perform any of the various algorithms and calculations described herein. Processor 328 may be embodied as a general-purpose integrated circuit, an application-specific integrated circuit, a field-programmable gate array, and/or any other suitable programmable logic device. Such instructions may include information for processing routing and data packets received via communications subsystem 320.

Communications subsystem 320 comprises a plurality of ports 316a-316c, each of which may be in communication with a different device. In the illustrated embodiment, port 316c is in communication with SDN controller 302 and may represent a connection to a control plane of an SDN network. Port 316a is in communication with host 360a, and port 316b is in communication with host 360b.

A traffic routing subsystem 318 may implement a plurality of communication flows 326. Traffic routing subsystem 318 may receive a plurality of communication flows 326 from SDN controller 302. The communication flows 326 may be used to identify communications authorized to pass through switch 350 and route such communications. Communications that are not authorized by communication flows 326 may be blocked by switch 350. Traffic routing subsystem 318 may control the flow of data between devices connected to ports 316a-316c.

Hosts 360a and 360b may represent a pair of devices that communicate via switch 350. In one specific example, hosts 360a and 360b may be embodied as devices in an electric power system, such as a pair of protective relays. Hosts 360a and 360b include processors 362a and 362b, respectively, that may execute instructions stored in memory 364a and 364b, respectively. Sensor components 370a and 370b may gather information to be communicated, such as voltage or current measurements. Hosts 360a and 360b may be in communication with switch 350 using communications subsystems 368a and 368b, respectively.

One of the communication flows 326 implemented by switch 350 may enable such communication. The IP addresses or other criteria associated with hosts 360a and 360b may be fixed, and as such, switch 350 may route data packets between hosts 360a and 360b without MAC addresses. Accordingly, host 360a may generate a packet for host 360b without including the actual MAC address of host 360b. Instead, the MAC address may be fixed, random, or used to communicate other information. Upon receipt of the packet, switch 350 may route the packet based on an IP address or other information such as a hostname. In such embodiments, information in a MAC address field of a packet may be disregarded. In other embodiments, switch 350 may substitute or modify information originally included in the MAC address field for the actual MAC address of host 360b. Further, in some embodiments, the communications subsystems 320, 368a and 368b may include modifications to a communications stack to enable routing of information without reference to MAC addresses and/or to utilize a MAC address field to communicate other types of information.

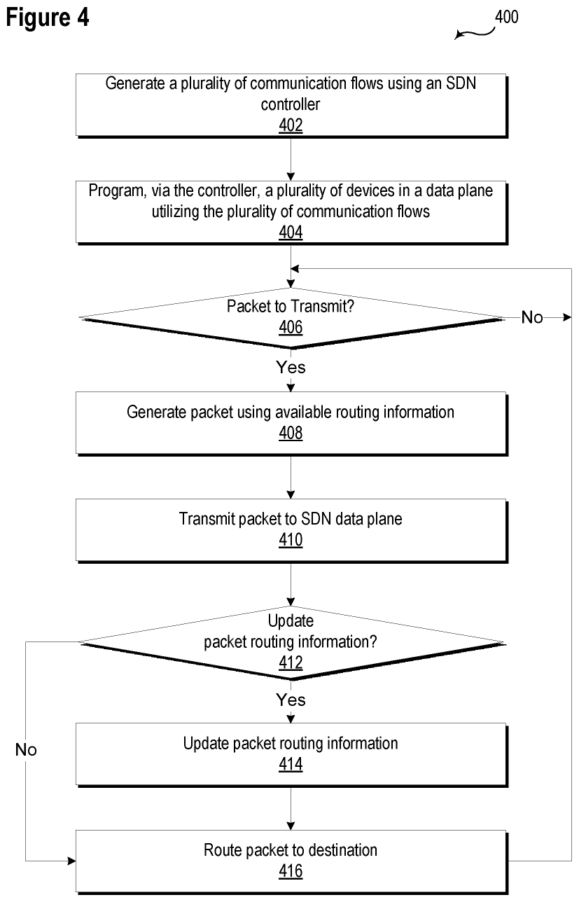

FIG. 4 illustrates a flowchart of a method 400 for transmitting a message in an SDN consistent with the embodiments in the present disclosure. At 402, a plurality of communication flows may be generated using an SDN controller. Various techniques may be utilized to generate communication flows. For example, an operator may specify communication below or communication flows may be generated automatically.

At 404, a plurality of devices in a data plane may be programmed by the controller using the plurality of communication flows. After programming, the devices in the data plane may route traffic based on the communication flows. In some embodiments, traffic that is not authorized by a communication flow (e.g., ARP requests) may be blocked.

At 406, method 400 may await a packet to transmit. For example, in an electric power system, a packet may be generated to represent a measurement of or a change in an electrical condition.

At 408, a transmitting host may generate the packet using available routing information (e.g., an IP address, a hostname, etc.). In various embodiments, the available information may exclude a MAC address for the destination host. Packet fields associated with the missing information may be represented by static values, random values, or populated with other types of information.

At 410, the data packet generated at 408 may be transmitted to the SDN data plane for routing to the destination device.

At 412, a data plane device that receives the packet may determine whether to update the packet with additional routing information. For example, the receiving device may modify the MAC address field to include the destination device's MAC address. If updated packet routing information is not necessary, method 400 may proceed to 416 and the packet may be routed to the destination.

At 414, packet routing information may be updated. In an SDN, the controller may include a complete list of MAC addresses, IP addresses, and other routing information associated with each device authorized to communicate in the SDN. The controller may supply such information to other devices in the data plane (e.g., switches), and such information may be used to update packets. In this way, ARP traffic and the associated security risks may be eliminated from the network, without modification of standard communication protocols. The updated packet may be routed to the destination at 416.

While specific embodiments and applications of the disclosure have been illustrated and described, it is to be understood that the disclosure is not limited to the precise configurations and components disclosed herein. Accordingly, many changes may be made to the details of the above-described embodiments without departing from the underlying principles of this disclosure. The scope of the present invention should, therefore, be determined only by the following claims.

What is claimed is:

1. A system to eliminate address resolution protocol (“ARP”) traffic in a software-defined network (“SDN”), the system comprising:
a controller in a control plane of the SDN and comprising:
a traffic routing subsystem to:
generate a plurality of communication flows; and
program a plurality of network devices in a data plane based on the plurality of communication flows; and
a communication flow subsystem in communication with a data plane; and
a plurality of network devices in the data plane, each of the plurality of network devices comprising:
a communication subsystem in communication with at least one other network device in the data plane, the communication subsystem to:
receive at least a portion of the plurality of communication flows from the communication flow subsystem;
receive a packet from a transmitting host in communication with the data plane;
determine a destination host specified in the packet without reliance on an original media access control (“MAC”) address in the packet; and
route the packet to the destination host.

2. The system of claim 1, wherein the destination host comprises a modified communication stack to disregard the original MAC address.

3. The system of claim 1, wherein a MAC address data field in the packet is repurposed to communicate another type of information.

4. The system of claim 3, wherein the MAC address data field in the packet is repurposed to represent one of a message type and a message priority.

5. The system of claim 1, wherein the communication subsystem generates a modified MAC address and substitutes the modified MAC address for the original MAC address in the packet.

6. The system of claim 5, wherein the modified MAC address comprises a MAC address of the destination host.

7. The system of claim 5, wherein the controller provides the MAC address of the destination host to the at least one of the plurality of network devices in the data plane.

8. The system of claim 1, wherein at least one of the plurality of network devices blocks ARP traffic.

9. The system of claim 1, wherein the original MAC address comprises one of a fixed value and a random value.

10. The system of claim 1, wherein at least one of the transmitting host and the destination host comprise a device in an electric power system.

11. A method for eliminating address resolution protocol (“ARP”) traffic in a software-defined network (“SDN”), the method comprising:
generating, using a controller in a control plane of the SDN, a plurality of communication flows;
programming, using the controller, a plurality of network devices in a data plane based on the plurality of communication flows;
receiving, using at least one of a plurality of network devices in the data plane, at least a portion of the plurality of communication flows from the controller;
receiving, using at least one of the plurality of network devices in the data plane, a packet from a transmitting host in communication with the data plane;
determining, using at least one of the plurality of network devices in the data plane, a destination host specified in the packet without reliance on an original media access control (“MAC”) address in the packet; and
routing, using at least one of the plurality of network devices in the data plane, the packet to the destination host.

12. The method of claim 11, wherein the destination host comprises a modified communication stack to disregard the original MAC address.

13. The method of claim 11, further comprising repurposing a MAC address data field in the packet to communicate another type of information.

14. The method of claim 13, wherein the MAC address data field in the packet is repurposed to represent one of a type and a message priority.

15. The method of claim 11, further comprising:
generating, using at least one of a plurality of network devices in the data plane, a modified MAC address; and
substituting, using at least one of a plurality of network devices in the data plane, the modified MAC address for the original MAC address in the packet.

16. The method of claim 15, wherein the modified MAC address comprises a MAC address of the destination host.

17. The method of claim 15, further comprising providing, using the controller, the MAC address of the destination host to the at least one of the plurality of network devices in the data plane.

18. The method of claim 11, further comprising blocking, using the plurality of network devices, ARP traffic.

19. The method of claim 11, wherein the original MAC address comprises one of a fixed value and a random value.

20. The method of claim 11, wherein at least one of the transmitting host and the receiving host comprise a device in an electric power system.
